(19) United States
(12) Patent Application Publication
(10) Pub. No.: US 2006/0080802 A1
(43) Pub. Date: Apr. 20, 2006

(54) Self-propelled cleaner charging-type travel system and charging-type travel system

(75) Inventor: Takao Tani, Osaka (JP)

Correspondence Address: YOKOI & CO. U.S.A., INC., 13700 MARINA POINTE DRIVE #723, MARINA DEL RAY, CA, 90292, US

(73) Assignee: Funai Electric Co., Ltd., Osaka (JP)

(21) Appl. No.: 11/239,844

(22) Filed: Sep. 30, 2005

(30) Foreign Application Priority Data
Oct. 18, 2004 (JP) JP2004-302757

(51) Int. Cl. A47L 5/00

(52) U.S. Cl. 15/319

(57) ABSTRACT

When a residual quantity of a battery of a self-propelled cleaner is decreased, automatic cleaning is interrupted and driving of a cleaner mechanism is simultaneously stopped, and when a forward obstacle is detected while allowing a self-propelled cleaner to be traveled along a wall, a rotary encoder measures a traveling distance of a cleaner body BD, thereby measuring a depth of the obstacle. Then, in a case where the measured traveling distance (X) is equal to a width (H) of a charger device that projects from the wall, it is judged that the obstacle is the charger device, and traveling of the self-propelled cleaner is controlled in such a manner that its charging terminal is operatively connected to an electrical supply terminal of the charger device. Thus said charging-type travel system is precisely self-traveled to a charger device and cause itself be positively subjected to charging.

### BACKGROUND OF THE INVENTION

1. Field of the Invention

The present invention relates to a self-propelled cleaner charging-type travel system and a charging-type travel system and, in particular, to a system that comprises a self-propelled cleaner including a body provided with a cleaner mechanism and a driving mechanism responsible for steering and driving of the self-propelled cleaner, and a charger device for charging the self-propelled cleaner.

2. Description of the Prior Art

Hitherto, regarding a charging-type travel system that comprises a self-propelled device provided with a driving mechanism responsible for steering and driving of the self-propelled device, and a charger device for charging the self-propelled device, a technique in which when a residual quantity of a battery of the self-propelled device is decreased, the self-propelled device is self-traveled to the charger device and then charged is disclosed (for example, Japanese Patent Application Laid-Open Nos. 2002-45320, 2002-34878, Hei. 7-8428, Hei. 4-96719 and Hei. 4-53515).

Of the above-mentioned prior art systems, in the charging-type self-travel system disclosed in Japanese Patent Application Laid-Open Nos. Hei. 7-8428 and Hei. 4-53515, a guidance mechanism for guiding the self-propelled device to the charger device is provided on the side of the charger device, so that there is a problem that the cost of the charger device is increased. Also, in the charging-type self-travel system disclosed in Japanese Patent Application Laid-Open No. 4-96719, the present position of the self-propelled device is judged from a moving amount of the self-propelled device and the self-propelled device is then automatically traveled to the charger device on the basis of information about the present position and data on a setting position of the charger device, which are previously memorized. However, when the present position of the self-propelled device is judged from the moving amount of the self-propelled device, an error is apt to occur, so that there is a problem that it is difficult to cause the self-propelled device to be precisely traveled to the charger device.

### SUMMARY OF THE INVENTION

The present invention has been made in view of the foregoing problems. It is an object of the present invention to provide a charging-type travel system that facilitates restraining of raising cost, and can cause a self-propelled device to be precisely self-traveled to a charger device and then cause the travel device to be positively subjected to charging.

In order to attain the above-mentioned object, in accordance with one aspect of this invention, there is provided a charging-type travel system. The charging-type travel system comprises a travel device adapted to perform self-travel and a charger device adapted to be set on a wall surface of a room to be cleaned, the travel device comprising a cleaner mechanism, a body with the cleaner mechanism, a driving mechanism responsible for steering and driving of the travel device, forward obstacle sensors for detecting a forward obstacle, sidewall sensors for detecting a lateral obstacle, a charging terminal for facilitating charging of the travel device, and an automatic charge-controlling unit, and the charger device comprising an electrical supply terminal to which the charging terminal of the travel device is to be operatively connected, the automatic charge-controlling unit adapted to serve as means to cause the charging terminal to be operatively connected the electrical supply terminal of the charger device after the travel device is moved to a position near the charger device, and the automatic charge-controlling unit including a charger device search-controlling unit for causing the travel device to be traveled along a wall of the room, causing the travel device to be turned through an angle of 90° according to the detection of the forward obstacles by the forward obstacle sensor in the traveling of the travel device along the wall, measuring a depth of the same obstacle while causing the travel device to be traveled perpendicularly to the wall and judging whether or not the obstacle is the charger device, on the basis of the measuring results.

In the aspect constructed as described above, the charging-type travel system is comprised of the travel device and the charger device. The above-mentioned travel device includes the driving mechanism responsible for steering and traveling of the travel device, the forward obstacle sensors for detecting a forward obstacle, the sidewall sensors for detecting a lateral obstacle, and the charging terminal for facilitating charging of the travel device. The above-mentioned charger device is provided with the electrical supply terminal to which the charging terminal of the travel device is to be operatively connected, and is adapted to be set on the wall surface of the room so as to project from the wall surface.

The above-mentioned travel device is adapted to perform self-travel and includes the automatic charge-controlling unit that is adapted to serve as means to cause the charging terminal to be operatively connected to the electrical supply terminal of the charger device. That is, when data indicating that a residual quantity of a battery of the travel device is decreased or predetermined instructions to start charging are given, the travel device conducts a home control, which causes the travel device, having traveled at a location away from the charger device, to self-travel to the charger device, causes the charging terminal of the travel device to be operatively connected to the charger device, and then causes the travel device to be subjected to charging.

The automatic charge-controlling unit is adapted to cause the travel device to be traveled along the wall of the room. The automatic charge-controlling unit includes the charger device-search controlling means that is adapted to cause the travel device to turn through an angle of 90° when data representing that a forward obstacle is detected by the forward obstacle sensors are given during the traveling of the travel device along the wall of the room, measure a depth of the same obstacle while causing the travel device to be moved perpendicularly to the wall, and then judge on the basis of the measuring results whether or not the obstacle is the charger device. Namely, in the charging-type travel system according to claim 2, the travel device conducts a search for the charger device set on the wall while traveling along the same wall. Therefore, there is no need to provide a guidance device for guiding the travel device to the charger device, on the side of the charger device, and it is therefore possible to restrain an increase in the cost of the self-propelled system. Furthermore, the travel device conducts the search for the charger device, so that it can be precisely traveled to the location where the charger device is set.

In another aspect of the present invention, the above-mentioned travel device is provided with an encoder for measuring a traveling distance of the travel device on the basis of revolutions of wheels provided at the travel device and the above-mentioned charger device-search controlling means is such constructed that when data indicating that a forward obstacle has been detected by the forward obstacle sensor during the traveling along the wall are given, the charger device-search controlling unit causes the travel device to be turned through an angle of 90° and measure a traveling distance through the above-mentioned encoder during the detection of the obstacle by the sidewall sensors, while causing the travel device to be moved perpendicularly to the wall, thereby measure a depth of the obstacle.

In this aspect of the present invention that is constructed as described, while the depth of the projecting portion of the charger device that projects from the wall surface has been detected by the sidewall sensors, the above-mentioned encoder measures the traveling distance of the travel device, to thereby measure the depth of the obstacle. Thus, it is possible to judge on the basis of the measuring results whether or not the obstacle is the charger device.

In still another aspect of the present invention, the above-mentioned charger device is formed with a recess portion that is to be detected by the above-mentioned sidewall sensors of the travel device.

The above-mentioned automatic charge-controlling unit comprises a position-registering processor that causes the travel device to be turned through an angle of 90° and causes the travel device to be traveled in parallel with the wall, after the charger device is detected by the above-mentioned charger device-search controlling unit, and when data indicating that the recess portion has been detected by the above-mentioned sidewall sensors are given, stops the traveling of the travel device, and causes the travel device to conduct a position-registering between the above-mentioned travel device and the above-mentioned charger device.

In this aspect of the present invention that is constructed as discussed above, for example, in a case where the above-mentioned recess portion through the sensors is provided just below the electrical supply terminal provided at the charger device, when the travel device that has detected the recess portion is to be stopped, the travel device is stopped at a position where the travel device is opposed to the electrical supply terminal. Thus, it is possible to easily conduct the position-registering between the above-mentioned travel device and the above-mentioned charger device.

In still another aspect of the present invention, the charging terminal is provided at a rear side of the body of the travel device. The above-mentioned automatic charge-controlling unit is such constructed that it causes the travel device to be turned through an angle of 90° after the position-registering is performed and then causes the travel device to be moved back after the charging terminal provided at the rear side of the travel device body is opposed to the electrical supply terminal of the charger device, and causes the travel device to conduct an electrical connection between the charging terminal and the electrical supply terminal.

In this aspect of the present invention that is constructed as described above, it is possible to conduct the electrical connection between the charging terminal and the electrical supply terminal by merely causing the travel device body to be moved back after the 90° turn is performed.

In yet another aspect of the present invention, the travel device is constructed as a self-propelled cleaner provided with a cleaner mechanism.

According to this aspect of the present invention that is constructed as described above, there is no need for a user to perform cleaning of a room while carrying a cleaner. Therefore, this aspect can reduce the user's burden.

In yet another aspect of the present invention, the above-mentioned cleaner is such constructed as to be stopped while the automatic charging operation has been carried out by the above-mentioned automatic charge-controlling unit.

In this aspect of the present invention that is constructed as described above, it is possible to restrain the power used (for example, power to be used during the traveling along the wall) during the automatic charging-process is conducted.

In still another aspect of the present invention, the travel device includes image picking-up sensors and a suspicious person judging processor for analyzing image picking-up signals supplied by the image picking-up sensors and then judging whether or not a suspicious person has been detected by the image picking-up sensors.

According to this aspect of the present invention that is constructed as discussed above, the travel device can be such constructed as to have a crime-preventing function.

### BRIEF DESCRIPTION OF THE DRAWINGS

The object, other objects and many of the attendant advantages of the present invention will be readily appreciated as the same becomes better understood by reference to the following detailed description when considered in connection with the accompanying drawings, in which like reference designators denote like or corresponding parts throughout, wherein:

FIG. 1 is a perspective view showing an appearance of a self-propelled cleaner according to the present invention;

FIG. 2 is a bottom view of the self-propelled cleaner shown in FIG. 1;

FIG. 3 is a rear side view of the self-propelled cleaner shown in FIGS. 1 and 2;

FIG. 4 is a cross-sectional view of the self-propelled cleaner, taken on a plane indicated in FIG. 3 by a line A-A;

FIG. 5 is a view showing a state where a charger device according to the present invention is mounted;

FIG. 6 is a cross-sectional view of the charger device, taken on a plane indicated in FIG. 5 by a line B-B;

FIG. 7 is a block diagram illustrating a structure of the self-propelled cleaner shown in FIGS. 1 and 2;

FIG. 8 is a flowchart exhibiting a procedure for an automatic cleaning-performing process performed by the self-propelled cleaner;

FIG. 9 is a view illustrating an example of travel routes of the self-propelled cleaner when performing the automatic cleaning-operation;

FIG. 10 is a flowchart exhibiting a procedure for an automatic charging operation that is performed according to a call at a step S270 of the flowchart shown in FIG. 8;

FIG. 11 is a view showing an operation of the self-propelled cleaner at the time of performing the automatic charging-operation exhibited in FIG. 10; and

FIG. 12 is a view showing an operation of the self-propelled cleaner at the time of performing the automatic charging-operation exhibited in FIG. 11.

### DESCRIPTION OF THE PREFERRED EMBODIMENTS

Now, embodiments of the present invention will be discussed hereinafter in the following order:

(1) an appearance of a self-propelled cleaner;

(2) an internal construction of the self-propelled cleaner;

(3) an operation of the self-propelled cleaner;

(4) various variants; and

(5) summary.

(1) The Appearance of the Self-Propelled Cleaner:

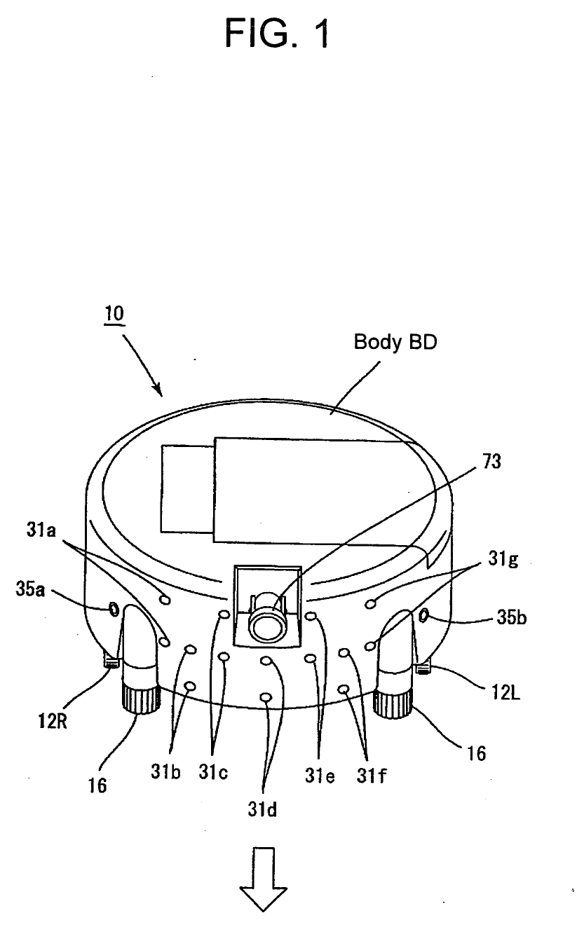

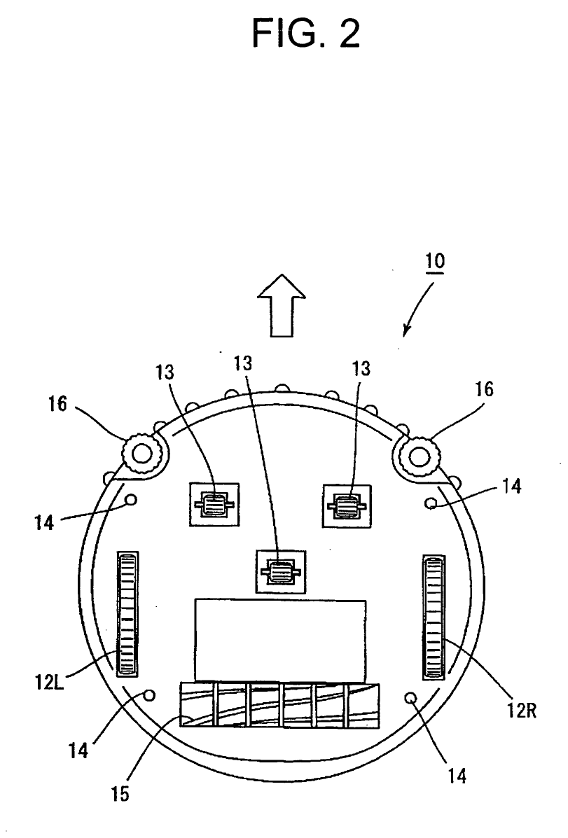

FIG. 1 is a view showing the appearance of the self-propelled cleaner according to the present invention. FIG. 2 is a bottom view of the self-propelled cleaner shown in FIG. 1. Incidentally, a direction indicated in FIG. 1 by an arrow is a traveling direction of the self-propelled cleaner at the time of advancing. As shown in FIG. 1, the self-propelled cleaner 10 according to the present invention includes a body BD of a substantially cylindrical shape and two drive wheels 12R, 12L (see FIG. 2) provided at a bottom side of the self-propelled cleaner. By driving of the drive wheels 12R, 12L separately, the self-propelled cleaner 10 can be advanced, moved back and turned. Furthermore, at a center portion of a front side of the body BD, an infrared CCD sensor 73 serving as an image picking-up sensor is provided.

Furthermore, seven ultrasonic sensors 31 (31a-31g) acting as forward obstacle sensors are provided at a portion of the body BD which is lower than the infrared CCD sensor 73. The ultrasonic sensors 31 comprise dispatching sections for generating supersonic waves and receiver sections for receiving the supersonic waves that are provided by the dispatching sensors 31, reflected by a forward wall and then returned. The ultrasonic sensors 31 are adapted to be capable of calculating a distance between the self-propelled cleaner and the wall from time that is required from the providing of the supersonic waves by the dispatching sections to the receiving of the supersonic waves by the receiver sections. Of the seven ultrasonic sensors 31, the ultrasonic sensor 31d is provided at the center portion of the front side of the body BD, the ultrasonic sensors 31a, 31g are symmetrically arranged at a left side and a right side, respectively, the ultrasonic sensors 31b, 31f are symmetrically arranged at the left side and the right side, respectively, and the ultrasonic sensors 31c, 31e are symmetrically arranged at the left side and right side, respectively. When the traveling direction of the body BD is perpendicular to the forward wall, distances that are calculated by the ultrasonic sensors 31 symmetrically arranged at the left and right sides are all same.

Furthermore, pyroelectric sensors 35 (35a, 35b) serving as human sensors are provided at the left side and right side of the front of the body BD, respectively. The pyroelectric sensors 35a, 35b can sense infrared rays generated from the human body and then detect the human who is present in the vicinity of the body BD. Incidentally, though not shown in FIG. 1, pyroelectric sensors 35 (35c, 35d) are also provided at the left and right sides of a rear of the body BD, respectively. Thus, a sensing range of 360 degrees around body BD can be obtained by the pyroelectric sensors 35.

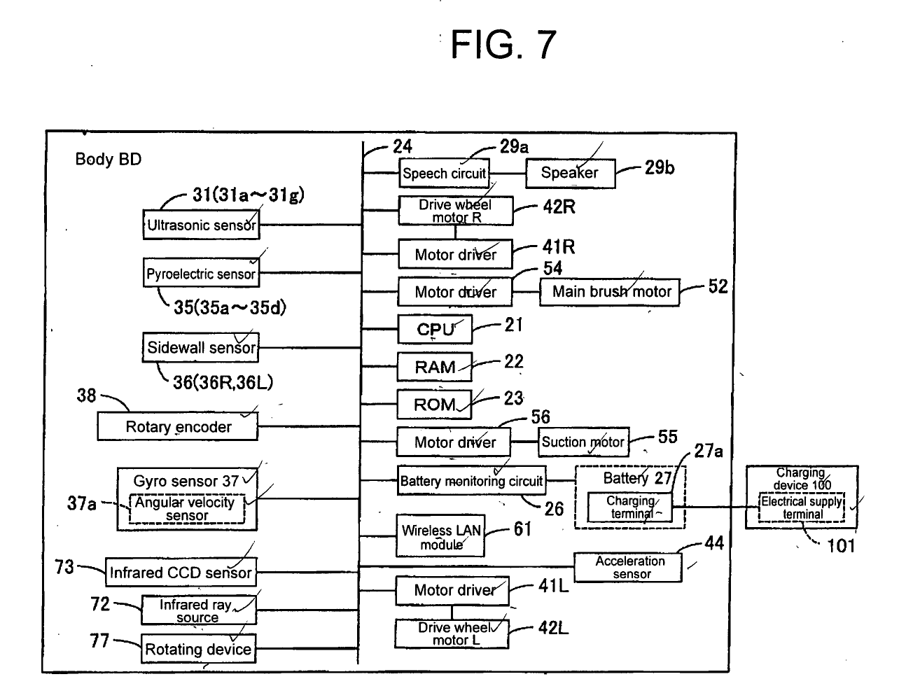

As shown in FIG. 2, the two drive wheels 12R, 12L are provided at the left and right sides of the bottom of the body BD, respectively. Furthermore, three supplementary wheels 13 are provided at a forward side of the bottom of the body BD (on the side of the traveling direction). Furthermore, step sensors 14 for detecting unevenness of a floor surface and steps of the floor surface are provided at the upper right-hand region, the lower right-hand region, the upper left-hand region and the lower left-hand region of the bottom of the body BD. A main brush 15 is provided at a region of the bottom of the body that is lower than the center portion of the bottom of the body BD. The main brush 15 is driven by a main brush motor 52 (shown in FIG. 7) and can sweep dirt and/or dust on the floor surface. An opening in a portion of the body BD to which the brush 15 is attached is a suction inlet. The dirt and/or dust is adapted to be sucked into the suction inlet while being swept by the main brush 15. Furthermore, side brushes 16 are provided at the upper right-hand region and the upper left-hand region of the bottom of the body BD, respectively.

Incidentally, though the self-propelled cleaner according to the present invention is provided with various sensors in addition to the ultrasonic sensors 31, the pyroelectric sensors 35 and the step sensors 14 that are shown in FIGS. 1 and 2, the various sensors other than the sensors 31, 35, 14 will be discussed hereinafter with reference to FIG. 7.

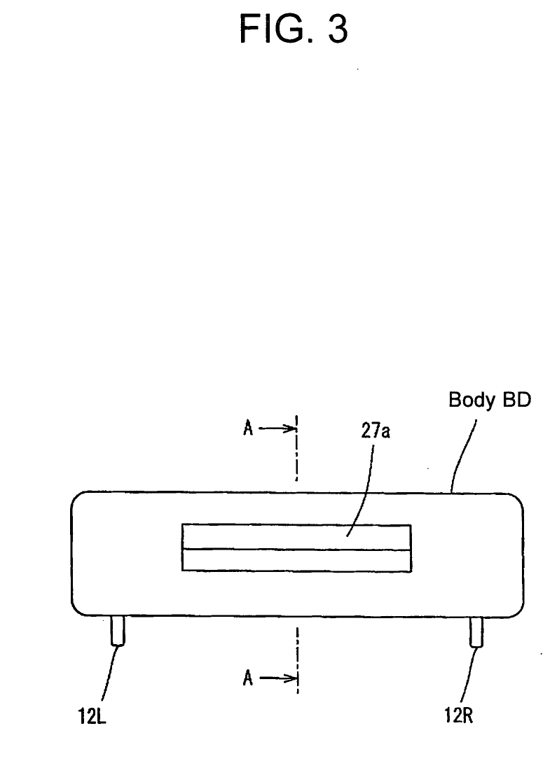

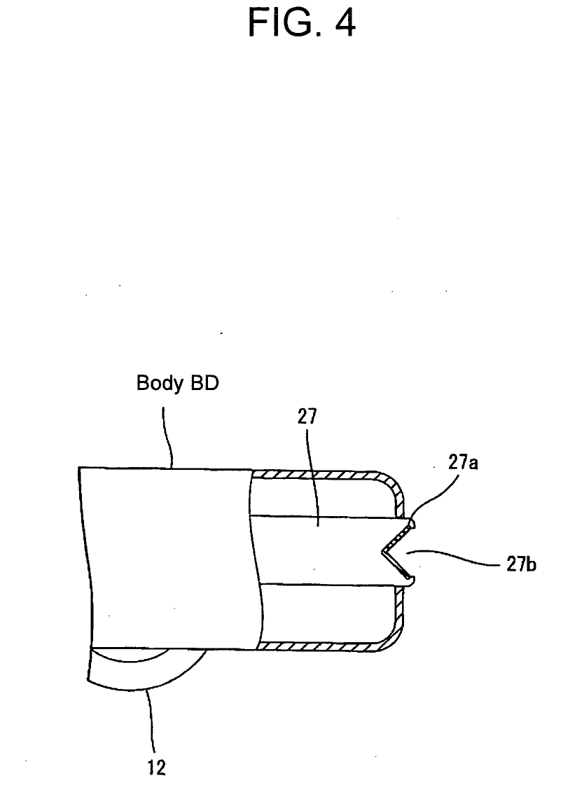

FIG. 3 is a rear side view of the self-propelled cleaner shown in FIGS. 1 and 2. FIG. 4 is a cross-sectional view of the self-propelled cleaner, taken on a plane indicated in FIG. 3 by a line A-A. As shown in FIGS. 3 and 4, formed at a circumferential portion of the rear side of the cylindrical-shaped body BD is a charging terminal 27a that is to be operatively connected to a charger device 100 which will be discussed hereinafter, and then performs charging of the self-propelled cleaner in cooperation with the charger device. On the other hand, a battery 27 is provided in an interior of the body BD as shown in FIG. 4. A rear end of the battery 27 is exposed to the out side of the body BD. And at the rear end of the battery 27, there is provided a recess portion 27b of a V-shape in cross-section. The charging terminal 27a is formed in the recess portion 27b.

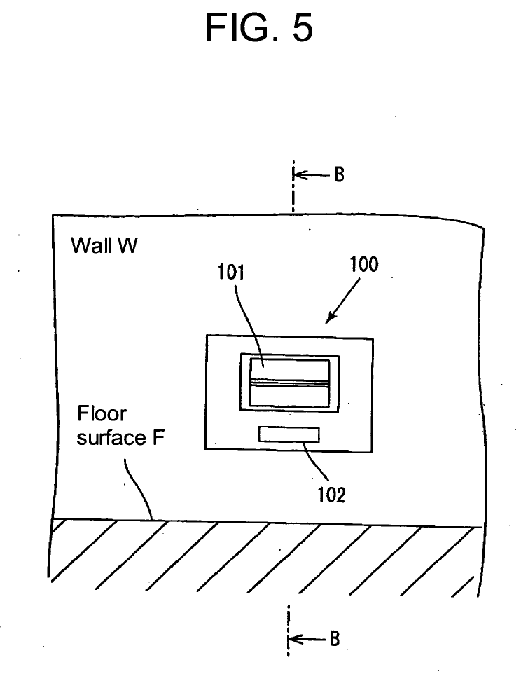

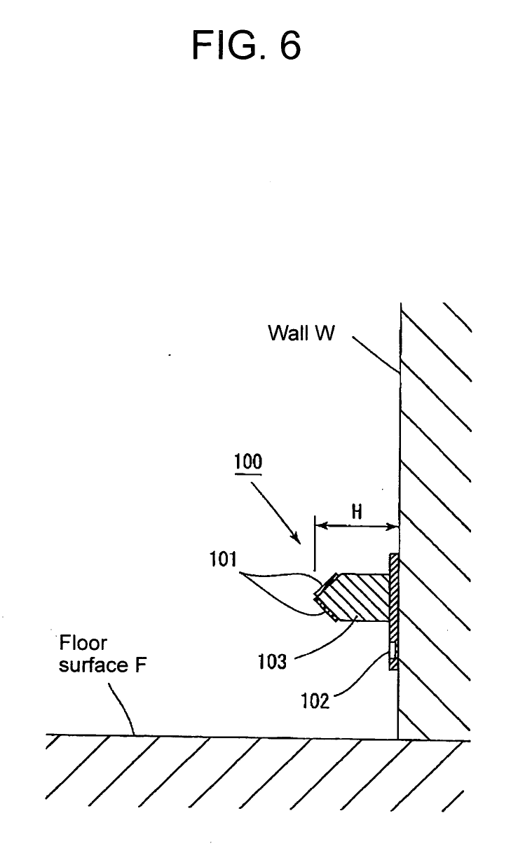

FIG. 5 is a view illustrating a state where the charger device according to the present invention is mounted. FIG. 6 is a cross-sectional view of the charger device, taken on a plane indicated in FIG. 5 by a line B-B. As shown in FIG. 5, the charger device 100 is mounted onto a region of a wall surface W that is spaced away from the floor surface at a predetermined height. The charger device 100 is provided with an unshown plug, and mounted onto the wall surface by inserting the plug into an unshown socket set on the wall surface W and can conduct charging. As shown in FIG. 6, the charger device 100 has a protruding portion 103 of a V-shape in cross-section provided at a tip end thereof. An electrical supply terminal 101 is provided at the protruding portion 103. In a condition where the charger device 100 is set on the wall surface W, it projects forward from the wall surface W by a predetermined width (H). The electrical supply terminal 101 is provided at a lower portion thereof with a recess portion 102 for position-registering between the self-propelled cleaner and the charger device. The recess portion 102 is to be detected by sidewall sensors 36 (36R, 36L) comprised of photo reflectors that will be discussed hereinafter, and acts as means to facilitate the position-registering between the self-propelled cleaner 10 and the charger device 100. This position-registering operation will be described hereinafter.

(2) The Internal Construction of the Self-Propelled Cleaner:

FIG. 7 is a block diagram illustrating the structure of the self-propelled cleaner shown in FIGS. 1 and 2. As shown in FIG. 7, a CPU 21, a ROM 23 and a RAM 22 that serve as a control section are electrically connected through a bus 24 to the body BD. The CPU 21 uses the RAM 22 as a work area and performs various controls according to control programs and parameter tables that are memorized in the ROM 23.

The body BD includes the battery 27. The CPU 21 is designed so as to be capable of monitoring a residual quantity of the battery 27 through a battery monitoring circuit 26. The battery 27 is provided with the charging terminal 27a that is to be used at the time of charging of the self-propelled cleaner by the charger device 100. The charging terminal 27a is operatively connected to the electrical supply terminal 101 of the charger device 100, whereby the self-propelled cleaner is subjected to charging. The battery monitoring circuit 26 mainly monitors a charging voltage of the battery 27 and then detects the residual quantity of the battery 27. Furthermore, the body BD has a speech circuit 29a that is electrically connected to the bus 24. A speaker 29b generates voice according to speech signals that are produced in the speech circuit 29a.

Furthermore, the body BD is provided with the ultrasonic sensors 31 (31a-31g) acting as the forward obstacle sensors, the pyroelectric sensors 35 (35a-35d) serving as the human sensors, and the step sensors 14 (see FIGS. 1 and 2). Also, the body BD is provided with the sidewall sensors 36R, 36L for detecting sidewalls, as the other sensors that are not shown in FIGS. 1 and 2. The sidewall sensors 36R, 36L are comprised of the photo reflectors that comprise the dispatching sections for generating infrared rays, and receiver sections for receiving the infrared rays that are reflected by the walls. However, as the sidewall sensors that are employed in the present invention, there may be employed ultrasonic sensors or the like. Furthermore, the body BD is provided with a gyro sensor 37 as one of the other sensors described above. The gyro sensor 37 comprises an angular velocity sensor 37a for detecting a change in an angular velocity that occurs due to change in the traveling direction of the body BD, and can detect an angle of a direction to which the body BD is directed, by multiplying a sensor output value detected by the angular velocity sensor 37a.

The self-propelled cleaner 10 according to the present invention is provided with motor drivers 41R, 41L, drive wheel motors 42R, 42L, and an unshown gear unit arranged between the drive wheel motors 42R, 42L and the above-mentioned drive wheels 12R, 12L, as a driving mechanism. When the body BD is turn-traveled, the rotation direction and rotation angle of the drive wheel motors 42R, 42L are particularly controlled by the motor drivers 41R, 41L. The respective motor drivers 41R, 41L output driving signals corresponding to control signals from the CPU 21. Incidentally, as the gear unit and the drive wheels 12R, 12L, there may be employ various gear units and drive wheels. The driving of the body BD may be performed by causing round-shaped rubber tires to be driven or causing an endless belt to be traveled.

Furthermore, the body BD is provided with a rotary encoder 38. This rotary encoder 38 is attached integrally with the drive wheel motors 42R, 42L and adapted to be capable of calculating a travel distance of the body BD from the number of revolutions of the drive wheels 12R, 12L. Incidentally, the rotary encoder 38 may not be attached directly to the drive wheel motors and a freely rotatable driven wheel may be provided in the vicinity of the drive wheels. In this case, a rotating amount of the driven wheel is fed back, whereby an actual rotating amount of the drive wheels can be detected even if slipping of the drive wheels occurs. An acceleration sensor 44 detects accelerations in three XYZ-axial directions, and then outputs the detection results.

The cleaner mechanism of the self-propelled cleaner 10 according to the present invention comprises the two side brushes 16 provided at the bottom of the body BD (see FIG. 2), the main brush 15 provided at the central portion of the bottom of the body BD (see FIG. 2), and a suction fan (not shown) for sucking dirt and/or dust swept by the main brush 15 and facilitating storing of the dirt and/or dust in a dust box 90. The main brush 15 is adapted to be driven by the main brush motor 52. The suction fan is adapted to be driven by a suction motor 55. Motor drivers 54, 56 are adapted to supply driving power to the main brushmotor 52 and the suction 55, respectively. The CPU 21 is adapted to suitably judge the cleaning performed by the main brush 15, according to a condition of the floor surface, a condition of the battery and instructions from the user, and then control the cleaning.

The body BD has a wireless LAN module 61. The CPU 21 is adapted to be capable of communicating with an external LAN on a radio according to a predetermined protocol. On the assumption that an unshown access point is present, the wireless LAN module 61 shall be governed by an environment in which the access point can be electrically connected to an external wideband network (for example, an internet) through routers or the like. Therefore, it is possible to carry out transmit-receive of usual mail and reading of web sites through the internet. Incidentally, the wireless LAN module 61 is comprised of a standardized card slot, a standardized wireless LAN card, which is connected to the slot, and the like. Of course, a different standardized card can be connected to the card slot.

Furthermore, the body BD is provided with an infrared CCD sensor 73 and an infrared ray source 72. Image picking-up signals that are produced in the infrared CCD sensor 73 are sent through the bus 24 to the CPU 21, in which various processes are performed with respect to the image picking-up signals. The infrared CCD sensor 73 has an optical system that can pick up a forward image, and produces electric signals according to infrared rays that are inputted from a sight that is realized by the optical system. Concretely, there are provided a plurality of photodiodes that are arranged correspondingly to respective picture elements at an image formation location where is determined by the above-mentioned optical system. The respective photodiodes produce electric signals that correspond to electrical energies of the inputted infrared-rays. A CCD element temporarily memorizes the electric signals that are produced for every picture elements. For the respective picture elements, the electric signals produce continued image picking-up signals. Then, the produced image picking-up signals are suitably outputted to the CPU 21.

(3) The Operation of the Self-Propelled Cleaner:

Now, the operation of the self-propelled cleaner 10 according to the present invention will be discussed hereinafter.

The self-propelled cleaner 10 according to the present invention is constructed so as to be capable of carrying out cleaning while automatically traveling according to the control programs memorized in the ROM 23 or the like. When a wall or unevenness of a floor surface is detected by the sensors in cleaning by the cleaner having automatically traveled, the traveling of the cleaner is controlled on the basis of the above-mentioned control programs.

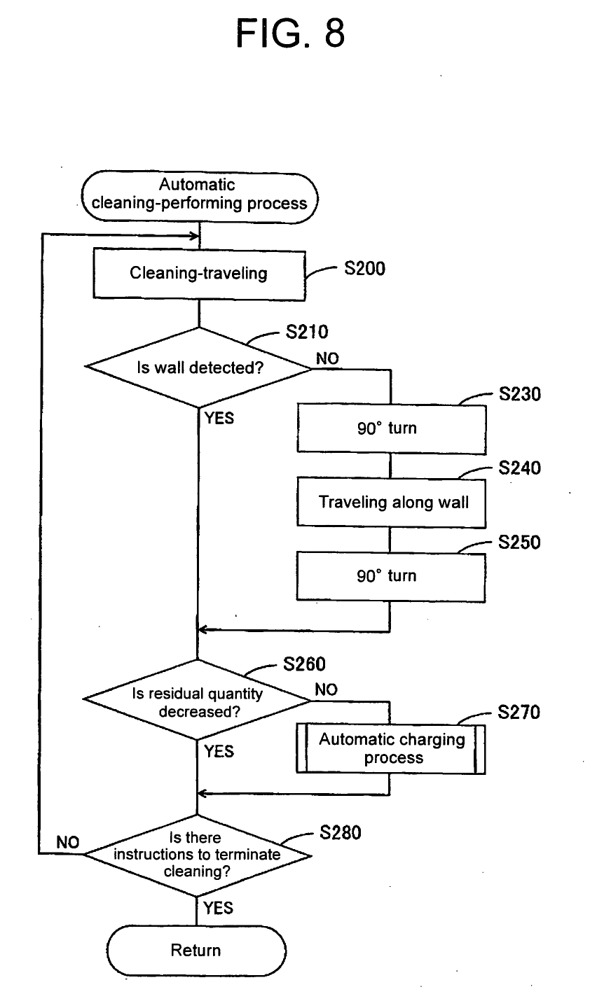

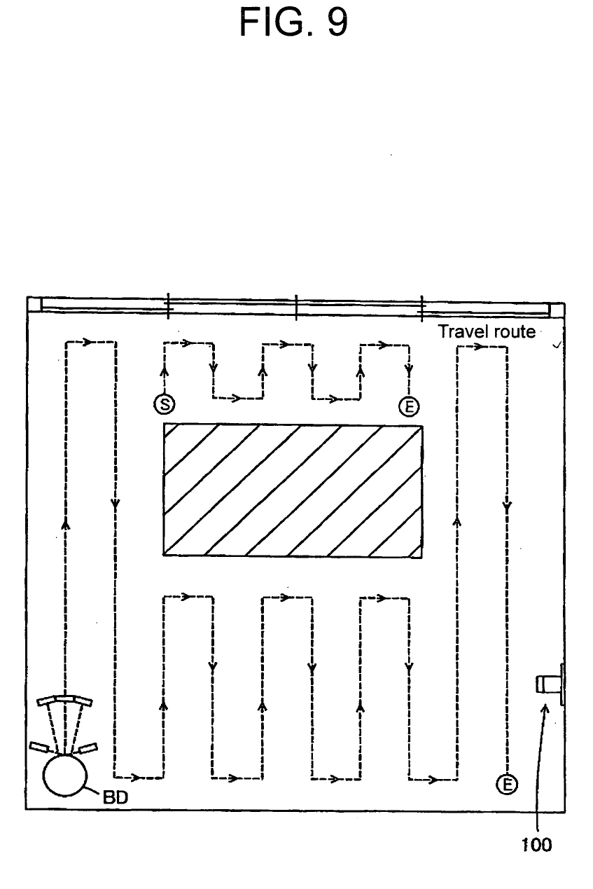

An automatic cleaning-performing process that is performed by the self-propelled cleaner 10 according to the present invention will described hereinafter with reference to a flowchart of FIG. 8. FIG. 8 is a flowchart exhibiting a procedure for an automatic cleaning-performing process performed by the self-propelled cleaner. FIG. 9 is a view schematically illustrating an example of travel routes of the self-propelled device when performing the automatic cleaning-performing process. First of all, cleaning and traveling are performed at a step S200. In the operation at the step S200, inputting of detection results obtained by the various sensors provided at the self-propelled cleaner 10 is performed while causing the drive wheel motors 42R, 42L to be driven and causing the body BD to be traveled straight-ahead, drive-controlling is performed based on the detection results, and cleaning is carried out while causing the main brush motor 52 and the suction motor 55 to be driven. Furthermore, when a change in a direction angle of the body BD which is detected by the gyro sensor 37 is detected, drive-controlling for the drive wheel 42R or the drive wheel 42L is performed, thereby correcting the travel direction of the body BD, and keeping the straight-ahead traveling of the body BD.

After the process at the step S200 is completed, whether or not a forward wall has been detected is judged at a step S210. That is, whether or not the forward wall located in the travel direction of the body BD has been detected by the ultrasonic sensors 31 is judged. When it is judged at the step S210 that the forward wall has been detected, a 90° turn of the body BD is carried out at a step S230. After this process is completed, the body BD is traveled in parallel with the wall. For example, when the cleaner starts to perform the cleaning and traveling from a cleaning start position shown in FIG. 9 and an upper wall shown in the Figure is detected, a 90° turn of the body BD in a right direction is performed. After the process at the step S230 is completed, traveling of the body BD along the wall is carried out at a step S240. In this process, the cleaning and traveling is performed while causing the main brush motor 52 and the suction motor 55 to be driven and causing the travel direction of the body BD to be controlled by the gyro sensor 37 in such a manner that the travel direction becomes parallel to the wall. After a predetermined distance-traveling of the body BD along the wall is completed at the step S240, a 90° turn of the body BD is again performed at a step S250. After the predetermined distance-traveling of the body BD along the upper wall shown in FIG. 9 is completed, a 90° turn of the body BD in the right direction is performed and the body BD then starts to travel in such a direction as to be perpendicular to the wall and away from the wall.

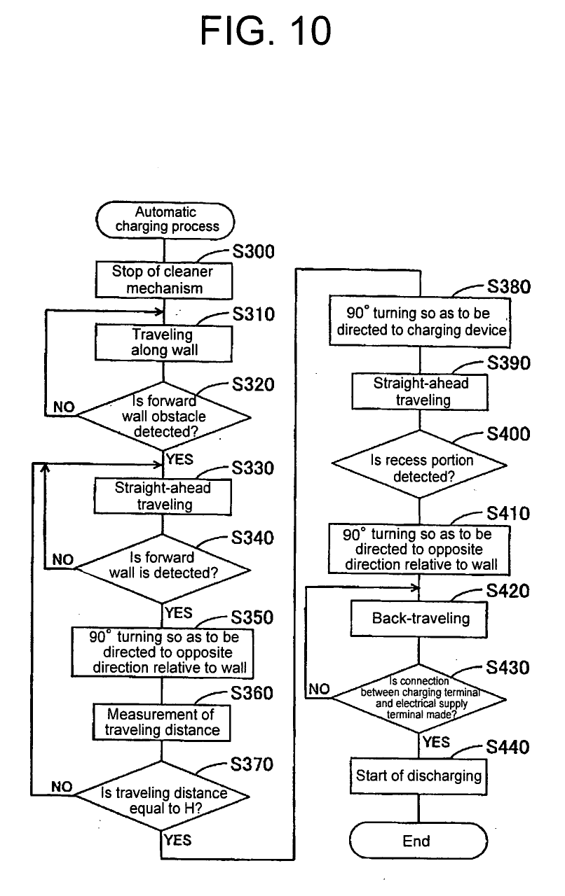

In a case where the process at the step S250 is completed or it is judged at the step S210 that the wall has not been detected, whether or not a residual quantity of the battery 27 is decreased is judged at a step S260. In this process, whether or not the residual quantity of the battery 27 that is detected by the battery monitoring circuit 26 has fallen below a predetermined reference level is judged. In a case where a decrease in the residual quantity of the battery 27 is judged at the step S260, an automatic charging-process is performed at a step S270. This process is achieved by causing the body BD to be automatically traveled to the charger device 100 set on a predetermined wall of a room to be cleaned, causing the charging terminal 27a of the body BD to be operatively connected to the electrical supply terminal 101 of the charger device 100, and performing charging. This automatic charging-process will be discussed in greater detail hereinafter with reference FIGS. 10-12.

In a case where the process at the step S270 is performed or it is judged at the step S260 that the residual quantity of the battery has not been decreased, whether or not instructions to terminate the cleaning are given is judged at a step S280. In a case where it is judged at the step S280 that no instructions have been given, the process is returned to the step S200. On the other hand, in a case where it is judged at the step S280 that the instructions have been given, the automatic cleaning-process is terminated.

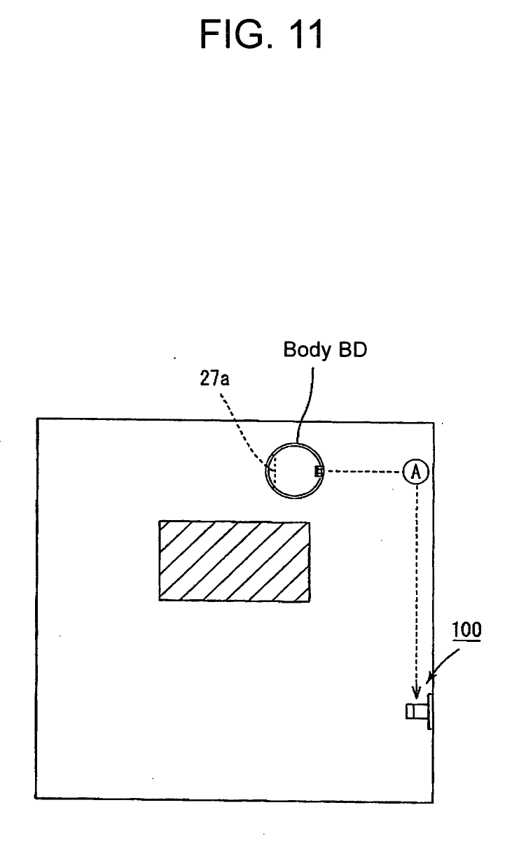

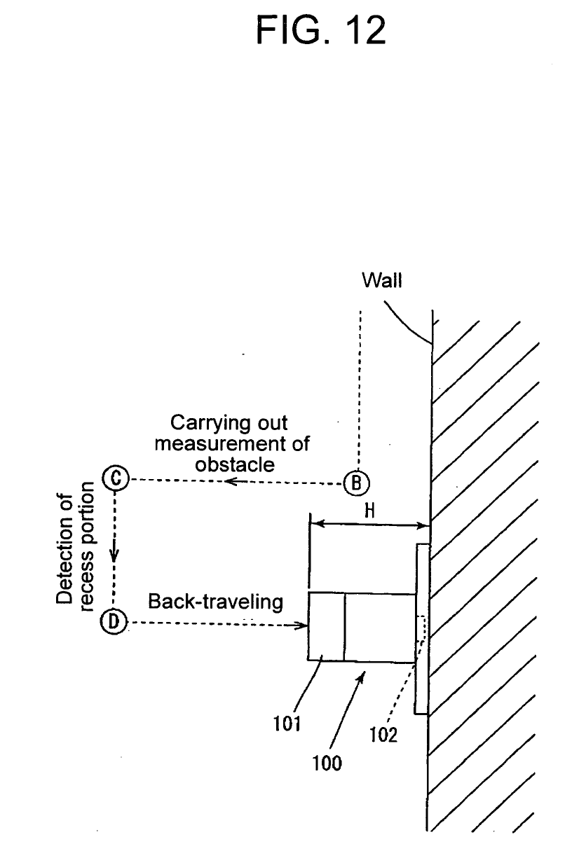

Now, the automatic charging-operation that is carried out according to a call at the step S270 in the flowchart shown in FIG. 8 will be discussed hereinafter. FIG. 10 is a flowchart exhibiting a procedure for the automatic charging-operation that is performed according to the call at the step S270 in the flowchart shown in FIG. 8. FIGS. 11 and 12 each is a view schematically showing an operation of the self-propelled cleaner when performing the automatic charging-operation exhibited in FIG. 10.

When the automatic charging-process shown in FIG. 10 is initiated, the operation of the cleaner mechanism provided at the self-propelled cleaner 10 is stopped at a step S300. Concretely, the operation of the main brush motor 52 for driving the main brush 15 is stopped by controlling the motor driver 54, and the operation of the suction motor 55 is stopped by controlling the motor driver 56. Then, straight-ahead traveling of the body BD is performed at a step S310. That is, the straight-ahead traveling of the body BD is carried out by driving the drive wheel motors 42R, 42L.

After the process at the step S310 is completed, whether or not the forward wall has been detected is judged at a step S320. That is, whether or not the forward wall has been detected by the ultrasonic sensors 31 is judged. In a case where it is judged at the step S320 that the forward wall has not been detected, the process is returned to the step S310 where the straight-ahead traveling of the body BD is continued. On the other hand, in a case where it is judged at the step S320 that the forward wall has been detected, traveling of the body BD along the wall is performed at a step S330. Concretely, a 90° turn of the body BD is performed after the body BD approaches the forward wall, and straight-ahead traveling of the body BD in parallel with the wall is then carried out.

After the process at the step S330 is performed, whether or not a forward obstacle has been detected is judged at a step S340. That is, whether or not a forward obstacle has been detected by the ultrasonic sensors 31 in the traveling of the body BD along the wall at the step S330 is judged. In a case where it is judged at the step S340 that no forward obstacle has been detected, the process is returned to the step S330 where the traveling of the body BD along the wall is continued. On the other hand, in a case where it is judged that a forward obstacle has been detected, a 90° turn of the body BD is performed at a step S350 in such a manner that the body BD is directed to the opposite direction relative to the wall.

After the process at the step S350 is completed, a traveling distance of the body BD is measured at a step S360. In this process, while detection of a lateral obstacle (an obstacle detected at the step S340) has been detected by the sidewall sensors 36 in the straight-ahead traveling, the measurement of the traveling distance of the body BD is performed by the rotary encoder 38. By the process at the step S360, it is possible to measure a depth of the obstacle.

After the process at the step S360 is completed, whether or not the traveling distance (X) is equal to the width (H) corresponding to the projecting amount of the charger device 100 set on the wall is judged at a step S370. Concretely, whether or not the traveling distance (X) measured by the rotary encoder 38 at the step S360 is equal to the width (H) corresponding to the projecting amount of the charger device 100 set on the wall is judged. That is, whether or not the obstacle detected at the step S340 is the charger device set on the wall is judged. Incidentally, data on the width (H) corresponding to the projecting amount of the charger device from the wall are previously memorized in the ROM 23 of the self-propelled cleaner 10 or the like. A comparison between the width (H) and the measured traveling distance (H) is made. When the above-mentioned steps S310-S370 are performed, the self-propelled device 10 serves as a charger device-search controlling unit.

In a case where it is judged at the step S370 that the traveling distance (X) is not equal to the width (H), the process is returned to the step S330. On the other hand, in a case where the traveling distance (X) is equal to the width (H) (in a case where the above-mentioned obstacle is the charger device 100), a 90° turn of the body BD is performed at a step S380 in such a manner that the body BD is directed to the charger device 100. Then, straight-ahead traveling of the body BD is performed at a step S390. After the processes at the steps S380, S390 are completed, traveling of the body BD is carried out in such a manner that the body BD becomes parallel to the wall and approaches the charger device 100.

After the process at the step S390 is completed, whether or not the recess portion 102 (see FIG. 5) formed in the charger device 100 for position-registering has been detected is judged at a step S400. That is, whether or not the recess portion 102 formed in the charger device 100 has been detected by either of the sidewall sensors 36 (36R, 36L) provided at the self-propelled cleaner 10 is judged. Incidentally, as one of methods for detecting the recess portion 102 by the sidewall sensors 36, there is employed the following method.

Since for the recess portion 102, infrared rays are reflected at locations which are away from the sidewall sensors 36, as compared to portions of the charger device 100 except the recess portion 102, output values of the sidewall sensors 36 with respect to the recess portion 102 and output values of the sidewall sensors with respect to the portions of the charger device 100 except the recess portion 102 are different. By using this, at the step 400, the output values of the sidewall sensors 36 at the time of infrared rays being reflected by the recess portion 102 are detected, whereby the presence of the recess portion 102 is detected.

In the illustrated embodiment, whether or not an obstacle is the charger device 100 depends upon whether or not the recess portion 102 is detected. However, it is possible to perform the judgment without using the recess portion 102. That is, just as a depth of an obstacle is measured as discussed above, a width of the protruding portion 103 of the charger device 100 may be measured. If a width to be measured coincides with the width of the protruding portion 103 that is previously grasped, it is judged that the obstacle is the charger device 100.

If it is judged at the step S400 that the recess portion 102 has not been detected, the process is returned to the step S390 where the straight-ahead traveling of the body BD is continued. On the other hand, if it is judged at the step S400 that the recess portion 102 has been detected, a 90° turn of the body BD is carried out at a step S410 in such a manner that the body BD is directed to the opposite direction relative to the wall. When this process is completed, the charging terminal 27a that is provided at the rear side of the body BD faces the electrical supply terminal 101 of the charger device 100.

After the process at the step S410 is completed, back-traveling of the body BD is performed at a step S420. When the body BD is traveled back, the charging terminal 27a provided at the body BD approaches the electrical supply terminal 101 of the charger device 100.

After the process at the step S420 is completed, whether or not the charging terminal 27a of the body BD has been operatively connected to the electrical supply terminal 101 of the charger device 100 is judged at a step S430. If it is judged that the connection has not been made, the process is returned to the step S420 where the back-traveling of the body BD is continued. On the other hand, if it is judged that the connection has been made, charging is started in the connection condition between the charging terminal 27a and the electrical supply terminal 101 at a step S440. After the process at the step S440 is completed, the automatic charging-operation is terminated.

An embodiment that may be employed at the time when the automatic charging-process shown in FIG. 10 is performed will be discussed hereinafter with reference to FIGS. 11 and 12. First, when it is detected that a residual quantity of the battery 27 has been decreased, the automatic charging-operation is interrupted, the cleaner mechanism of the body BD is stopped (step S300), and straight-ahead traveling of the body BD is performed (step S310). When the forward wall is detected by the ultrasonic sensors 31, the body BD approaches the wall, a 90° turn of the body BD is performed at a point A shown in FIG. 11, and the raveling of the body BD along the wall is carried out (step S330).

By the traveling of the body BD along the wall, the body BD approaches the charger device 100 as shown in FIG. 11. When the body BD approaches the charger device 100, the charger device 100 is detected by the ultrasonic sensors 31 as an obstacle (step S340). After the body BD approaches a point (point B in FIG. 12) near the forward obstacle (charger device 100), a 90° turn of the body BD is performed in such a manner that the body BD is directed to the opposite direction relative to the wall W (step S350) and measuring of a depth of the above-mentioned obstacle (charger device 100) is performed while causing the body BD to be moved away from the wall W (step S360). Since the measuring results (traveling distance X) coincide with the width (H) that corresponds to the projecting amount of the charger device 100 from the wall, it is judged that the obstacle is the charger device 100 (“YES” at the step S370).

If it is judged that the above-mentioned obstacle is the charger device 100, the body BD is traveled to a point C shown in FIG. 12. Thereafter, a 90° turn of the body BD is performed at the point C in such a manner that the body BD is directed to the charger device 100 (step S410), and detection of the recess portion 102 formed in the charger device 100 is performed while causing the body BD to be moved along the wall W (steps S390 and S400). When the recess portion 102 is detected, a 90° turn of the body BD is performed at a point (point D shown in FIG. 12) in such a manner that the body BD is directed to the opposite direction relative to the wall (step S410). At this time, the charging terminal 27a provided at the body BD becomes opposed to the electrical supply terminal 101 of the charger device 100. Then, the body BD is traveled back (step S420), thereby to make a connection between the charging terminal 27a and the electrical supply terminal 101 and perform charging.

(4) Various Variants:

While the case where the ultrasonic sensors are employed as the forward obstacle sensors in the above-mentioned embodiment is discussed above, the forward obstacle sensors that may be employed in the present invention are not limited to the ultrasonic sensors, insofar as they can detect forward obstacles. For example, as the forward obstacle sensors, there may be employed infrared CCD sensors (photo reflectors) that have infrared ray-generating sections and infrared ray receiver sections, or the like. Furthermore, while the case where the photo reflectors are employed as the sidewall sensors in the illustrated embodiment is described, the sidewall sensors that may be employed in the present invention are not limited to the photo reflectors, insofar as they can detect lateral obstacles such as sidewalls. For example, as the sidewall sensors, there may be employed ultrasonic sensors or the like.

Furthermore, while the case where the location-registering between the self-propelled cleaner and the charger device is performed by detecting the recess portion formed in the charger device in the illustrated embodiment is discussed above, the target to be detected is not limited to the recess portion, insofar as it can be detected. For example, as the target to be detected, there may be employed a protruding portion or any suitable means having a predetermined uneven pattern.

Furthermore, the case where the travel device that is one of mechanisms constituting the charging-type travel system is the self-propelled cleaner provided with the cleaner mechanism in the illustrated embodiment is discussed above, the travel device to which the present invention is applied is not limited to such a self-propelled cleaner and may be a travel device without such a cleaner mechanism. Furthermore, the present invention may be applied to a travel device that is not provided with image picking-up sensors for detecting a suspicious person (infrared CCD sensor 73).

(5) Summary:

As described above, in the embodiments according to the present invention, if a residual quantity of the battery 27 of the self-propelled cleaner 10 is decreased, the automatic cleaning-performing process is interrupted, the cleaner mechanism is stopped, and when the detection of the forward obstacle is performed while performing the traveling of the body along the wall, the measuring of the traveling distance of the body BD is performed by the encoder 38 while the obstacle has been detected by the sidewall sensors 36, thereby measuring the depth of the obstacle. If the measured traveling distance (X) is equal to the previously memorized width (H) which corresponds to the projecting amount of the charger device 100 from the wall, it is judged that the obstacle is the charger device 100, and the travel control of the body is performed in such a manner that the charging terminal 27a of the self-propelled cleaner 10 is operatively connected to the electrical supply terminal 101 of the charger device 100. Therefore, it is unnecessary to provide any guidance unit for guiding the self-propelled cleaner 10, on the side of the charger device 100. Thus, it is possible to restrain an increase in the cost of the charger device. Furthermore, since the self-propelled cleaner 10 is adapted to perform a search for the charger device 100, the self-propelled cleaner 10 can be positively moved to the location where the charger device 100 is set.

It should be noted that the terms and expressions having been employed herein are used as terms of description, not of limitation. In the use of such terms and expressions, there is no intention of excluding any equivalents of the features illustrated and described or portions thereof. However, it is recognized that various modifications are possible within the scope of the invention claimed.

We claim:

1. A self-propelled cleaner charging-type travel system comprising:
a self-propelled cleaner adapted to self-travel; and
a charger device adapted to be set on a wall surface of a room so as to project from said wall surface;
said self-propelled cleaner comprising:
a body provided with wheels;
a cleaner mechanism;
a driving mechanism responsible for steering and driving of said body;
a forward obstacle sensor for detecting a forward obstacle;
sidewall sensors for detecting a lateral obstacle;
a rotary encoder for measuring a traveling distance from revolutions of said wheels;
a charging terminal provided at a rear side of said body for facilitating charging of said self-propelled cleaner; and
an automatic charge-controlling unit;
said charger device including an electrical supply terminal to which said charging terminal of said self-propelled cleaner is operatively connected, and a recess portion to be detected by said sidewall sensors;
said automatic charge-controlling unit being adapted to facilitate operative connecting of said charging terminal to said electrical supply terminal of said charger device after said self-propelled cleaner moves near said charger device, and adapted to facilitate traveling of said body along a wall of a room;
said automatic charge-controlling unit comprising:
a charger device-search controlling unit adapted to receive data indicating that a forward obstacle has been detected by said forward obstacle sensor during the traveling of said body along said wall, then cause said body to be turned through an angle of 90°, cause said encoder to conduct measuring of a travel distance of said self-propelled cleaner during the detection of said lateral obstacle that is performed by said sidewall sensors while causing said body to be traveled perpendicularly to said wall, measure a depth of said lateral obstacle, and judge on the basis of measuring results whether or not said lateral obstacle is said charger device; and
a position-registering processor adapted to receive data indicating that said body is turned through the angle of 90° and travels in parallel with said wall, after said charger device is detected by said charger device-search controlling unit, and said recess portion has been detected by said sidewall sensors, cause the traveling of said body to be stopped, and then conduct a position-registering between said self-propelled cleaner and said charging device, wherein said self-propelled cleaner charging-type travel system is adapted cause said body to be turned through an angle of 90° after said position-registering is performed by said position-registering processor, to thereby cause said charging terminal provided at said rear side of said self-propelled cleaner body to be opposed to said electrical supply terminal of said charger device, and thereafter cause said self-propelled device body to be moved back, to thereby said charging terminal to be operatively connected to said electrical supply terminal.

2. A charging-type travel system comprising:
a travel device adapted to self-travel; and
a charger device adapted to be set on a wall surface of a room so as to project from said wall surface;
said travel device comprising:
a driving mechanism responsible for steering and driving of said travel device;
a forward obstacle sensor for detecting a forward obstacle;
sidewall sensors for detecting a lateral obstalce;
a charging terminal for facilitating charging of said travel device; and
an automatic charge-controlling unit;
said charger device including an electrical supply terminal to which said charging terminal of said travel device is to be operatively connected;
said automatic charge-controlling unit being adapted to cause said charging terminal to be operatively connected to said electrical supply terminal of said charger device after said travel device moves near said charger device;
said automatic charge-controlling unit including a charger device-search controlling unit adapted to cause said travel device to be travel led along said wall; and
said charger device-search controlling unit being adapted to receive data indicating that said forward obstacle has been detected by said forward obstacle sensors during the traveling of said travel device along said wall, then cause said travel device to be turned through an angle of 90°, measure a depth of said forward obstacle travel device while causing said travel device to be traveled perpendicularly to said wall, and judge on the basis of measuring results whether or not said forward obstacle is said charger device.

3. A charging-type travel system according to claim 2, wherein said travel device is provided with wheels and a rotary encoder for measuring a traveling distance of said travel device from revolutions of said wheels, and wherein said charger device-search controlling unit is adapted to receive data indicating that said forward obstacle has been detected by said forward obstacle sensor during the traveling of said body along said wall, then cause said travel device to be turned through an angle of 90°, cause said encoder to conduct the measuring of said traveling distance of said travel device during the detection of said lateral obstacle that is performed by said sidewall sensors while causing said travel device to be traveled perpendicularly to said wall, and measure a depth of said lateral obstacle.

4. A charging-type travel system according to claim 3, wherein said charger device includes a recess portion to be detected by said sidewall sensors, and wherein said automatic charge-controlling unit comprises a position-registering processor that is adapted to receive data indicating that said travel device has been turned through the angle of 90° and has traveled in parallel with said wall, after said charger device is detected by said charger device-search controlling unit, and said recess portion has been detected by said sidewall sensors, cause the traveling of said travel device to be stopped, and then conduct a position-registering between said self-propelled cleaner and said charging device.

5. A charging-type travel system according to claim 4, wherein said charging terminal is provided at a rear side of a body of said travel device, and wherein said automatic charge-controlling unit is adapted to cause said travel device to be turned through an angle of 90° and then cause said charging terminal provided at said rear side of said travel device body to be opposed to said electrical supply terminal of said charger device after said position-registering is performed by said position-registering processor, and thereafter cause said travel device body to be moved back, thereby cause said charging terminal to be operatively connected to said electrical supply terminal of said charger device.

6. A charging-type travel system according to claim 2, wherein said travel device comprises a self-propelled cleaner that is provided with a cleaner mechanism.

7. A charging-type travel system according to claim 6, wherein driving of said self-propelled cleaner is adapted to be stopped during performing of charging by said automatic charge-controlling unit.

8. A charging-type travel system according to claim 2, wherein said travel device includes image picking-up sensors and a suspicious person judging processors for analyzing image picking-up signals supplied by said image picking-up sensors and then judging whether or not a suspicious person has been detected by said image picking-up sensors.

9. A charging-type travel system according to claim 2, wherein said forward obstacle sensors comprises ultrasonic sensors that comprises dispatching sections for generating ultrasonic waves and receiver sections for receiving said ultrasonic waves that are sent from said dispatching sections, reflected by a forward wall of said room, and then returned, said ultrasonic sensors being adapted to be calculate distances between said travel device and said forward wall from time required from the sending of said ultrasonic waves by said dispatching sections to the receiving of said ultrasonic waves by said receiver sections.

10. A charging-type travel system according to claim 9, wherein said ultrasonic sensors are symmetrically disposed at left and right sides of a front surface of a body of said travel device, so that when a travel direction of said travel device body is perpendicular to said forward wall, the distances that are calculated by said ultrasonic sensors provided at the left and right sides of said front surface of said travel device body are all same.

11. A charging-type travel system according to claim 2, wherein said driving mechanism comprises two drive wheels provided at left and right sides of a bottom of a body of said travel device, and three supplementary wheels provided at a forward region of said bottom of said travel device body.

12. A charging-type travel system according to claim 4, wherein said position-registering recess portion is provided at a lower portion of said electrical supply terminal.

13. A charging-type travel system according to claim 12, wherein said sidewall sensors comprise photo reflectors and said recess portion is adapted to be detected by said sidewall sensors.

14. A charging-type travel system according to claim 2, wherein said sidewall sensors are comprised of photo reflectors that comprise dispatching sections for generating infrared rays and receiver sections for receiving said infrared rays reflected, and said sidewall sensors are adapted to detect sidewalls of said room.

15. A charging-type travel system according to claim 11, wherein said driving mechanism further includes motor drivers, drive wheel motors, a gear unit between said drive wheel motors and said drive wheels,

16. A charging-type travel system according to claim 13, wherein for said recess portion, reflected lights are obtained at locations where are away from said sidewall sensors, as compared to portions of said charger device except said recess portion, so that first output values of said sidewall sensors with respect to said recess portion and second output values of said sidewall sensors with respect to said portion of said charger device except said recess portion are different, said sidewall sensors being adapted to detect differences between said first and second output values, to thereby judge a presence of said recess portion.
